(19) United States
(12) Patent Application Publication
(10) Pub. No.: US 2021/0020908 A1
(43) Pub. Date: Jan. 21, 2021

(54) LITHIUM-EXCESS TRANSITION-METAL-DEFICIENT SPINELS FOR FAST CHARGING/DISCHARGING LITHIUM-ION BATTERY MATERIALS

(71) Applicant: The Regents of the University of California, Oakland, CA (US)

(72) Inventors: Gerbrand CEDER, Orinda, CA (US); HuiWen JI, Walnut Creek, CA (US)

(73) Assignee: The Regents of University of California, Oakland, CA (US)

(21) Appl. No.: 16/928,743

(22) Filed: Jul. 14, 2020

Related U.S. Application Data
(60) Provisional application No. 62/874,337, filed on Jul. 15, 2019.

(51) Int. Cl. H01M 4/134; H01M 4/131; H01M 4/525; H01M 4/505; H01M 4/36; H01M 4/1391; H01M 4/1395; H01M 10/0525; C01G 45/12

(52) U.S. Cl. CPC H01M 4/134; H01M 4/131; H01M 4/525; H01M 4/505; C01P 2002/32; H01M 4/1391; H01M 4/1395; H01M 10/0525; C01G 45/1242; H01M 4/364

(57) ABSTRACT

Li-ion battery materials, such as Li-ion cathodes, are provided that have spinels characterized by a close-packed face-centered-cubic rocksalt-type structure and spinel-like ordered TM (the TM preferably occupying one of the two octahedral sites 16c and 16d) that favor fast Li transport kinetics. Such spinels have a larger deviation from a normal spinel and have a formula. Li₁₊ₓTM_{2-y}O_{4-z}F_{z} where 0.2≤x≤1, 0.2≤y≤0.6, and 0≤z≤0.8; and TM is Mn, Ni, Co, Al, Sc, Ti, Zr, Mg, Nb, or a mixture thereof. The spinels achieve a higher gravimetric energy density than traditional spinels while still retaining high capacity at an extremely fast charging/discharging rate.

### FIELD OF THE INVENTION

The present invention relates to a class of lithium-excess, transition-metal-deficient spinels for fast charging/discharging lithium-ion (Li-ion) materials such as Li-ion battery materials (e.g., Li-ion cathodes). The Li-ion materials of the present invention being characterized by: (i) a lithium excess; (ii) partial cation disorder; and (iii) an overall cation to anion ratio between 3:4 and 1:1. These conditions enable the delivery of ultra-high capacity and fast charging/discharging rate performance, and allow for the partial substitution of fluorine for oxygen to achieve improved cycle life.

### BACKGROUND OF THE INVENTION

Provided at the end of the following disclosure is a listing of references that are considered potentially informative as to background aspects of the relevant technology and the state of the art. Some of the listed references are cited in the disclosure itself. The entire contents of each listed reference is incorporated herein by reference.

To enable mass-market electric vehicles with long driving ranges, short recharging time and instant acceleration, Li-ion battery materials, such as Li-ion cathodes, that are capable of storing and releasing large quantities of charge in a short period of time are urgently needed.^{1, 2} Traditionally, state-of-the-art, high-rate Li-ion battery materials are based on polyanionic compounds, e.g., LiFePO₄. However, the heavy polyanionic groups in these polyanionic compounds inevitably reduce their gravimetric and volumetric energy density.

Spinels have been previously explored as high-voltage materials, though previous studies focused on compositions that are largely stoichiometric and close to the ideal formula LiTM₂O₄ (TM=transition metals), with limited deviation (<0.2 per formula unit for Li, TM, or anionic species), and which only rely on transition metals to compensate for the charge transfer during cycling. In cases where Li was substituted for TM, e.g., Li_{5/3}Ti_{4/3}O₄, the overall cation to anion ratio remained stoichiometric (i.e., at 3:4).

### SUMMARY OF THE INVENTION

The present invention reflects a departure from the approach associated with Li-ion battery materials based on polyanionic groups, e.g., LiFePO₄. Materials of the present invention include those having a close-packed face-centered-cubic (FCC) rocksalt-type structure that favors dense energy storage as well as a spinel-like cation order that facilitates Li transport kinetics. In a close-packed rocksalt-type structure, among the various types of cation ordering configurations, a spinel-like cation order enables the most low-energy Li migration through tetrahedral intermediate sites with no face sharing transition metals (TMs), i.e., the so-called 0-TM channels, and therefore allows for the largest kinetically accessible Li capacity at any given Li level.³

The group of spinel oxides and oxyfluorides associated with the present invention have large and multiple degrees of tunability in Li-excess, TM deficiency, and fluorination levels (when present) at the same time. Spinels of the present invention are different from existing spinel compounds in several aspects. (i) Their compositions have larger deviation from an ideal spinel, with a formula of Li₁₊ₓTM_{2-y}O_{4-z}F (0.2≤x≤1, 0.2≤y≤0.6, 0≤z≤0.8, TM=Mn, Ni, Co, Al, Sc, Ti, Zr, Mg, Nb (can be a single TM element or a combination of multiple TMs). The maximum level of fluorination achieved, 0.8 per formula unit, is much higher than what has been reported in the literature, i.e. about 0.2 out of 4 anions per formula unit. (ii) These formulas are all over-stoichiometric in their cation sublattice, meaning that the cation to anion ratio (atomic) is larger than 3:4 yet smaller than 1:1 (3:4<r<1:1). (iii) The TM species are partially disordered between the two sets of octahedral sites, i.e., the 16c and 16d Wyckoff positions, whereas traditional spinels have TM species confined to one set of octahedral sites. This TM disorder also has an influence on the voltage profiles during electrochemical cycling. (iv) Spinels of the present invention are considered to be the only spinels that utilize oxygen redox during their charge/discharge, with the activation of oxygen redox considered to result from the unconventionally high levels of Li excess and TM deficiency in these compositions.

In one example, materials according to the present invention are obtained through an industrially scalable mechanochemical method. The materials thus obtained show exceptionally high energy density and excellent rate performance at the same time. The inventive compound is characterized by a maximum gravimetric energy density in the range of 1000 to 1155 Wh/kg, which is much higher than traditional spinels (e.g., <800 Wh/kg for LiMn₂O₄ or <950 Wh/kg for LiNi_{0.5}Mn_{1.5}O₄). In particular, materials of the present invention retain high capacity >100 mAh/g at an extremely fast charging/discharging rate of 20 A g⁻¹. In addition, using a high energy ball milling method, the Li, TM, and F contents can be systemically independently tuned to achieve optimized properties.

Materials according to the present invention are suitable for use as cathode, anode, and electrolyte materials in rechargeable lithium batteries. Though the discussion below may address specific examples (e.g., examples for a cathode only), it will be understood that such examples are non-limiting, and that invention is equally applicable to other uses (e.g., an anode, an electrolyte, etc.).

Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

FIGS. 1A and 1B shows scanning electron microscopy images of LMOF03 and LMOF06 (scale bars: 200 nm), respectively;

FIG. 2 shows a ¹⁹F spin echo ssNMR spectra obtained at 60 kHz MAS for LMOF03, LMOF06 and LiF on pristine sample powder;

FIGS. 3A-3D show a Rietveld refinement of LMOF03 at room temperature using four banks of time-of-flight (TOF) neutron diffraction data;

FIGS. 4A-4D show a Rietveld refinement of LMOF06 at room temperature using four banks of TOF neutron diffraction data;

FIGS. 5A-5E show a high-resolution TEM image of LMOF03, and electron diffraction imaging, with EDS mapping, of Mn, O, and F;

FIGS. 6A-6E show a high-resolution TEM image of LMOF06, and electron diffraction imaging, with EDS mapping, of Mn, O, and F;

FIGS. 7A-7F show galvanostatic cycling performance of LMOF03 (FIGS. 7A-7C) and LMOF06 (FIGS. 7D-7F) at 50 mA g⁻¹;

FIGS. 8A-8C show galvanostatic charge/discharge profiles of LMOF03 (FIG. 8A) and LMOF06 (FIG. 8B) at various rates, in comparison with state-of-the-art cathodes (FIG. 8C);

FIGS. 9A-9C show normalized XANES spectra of the Mn K-edge at selected states of charge and discharge during the first cycle and second charge, for LMOF03;

FIGS. 10A-10C show normalized XANES spectra of the Mn K-edge at selected states of charge and discharge during the first cycle and second charge, for LMOF06;

FIGS. 11A-11F show electronic structures of oxygen in LMOF03 at various states of charge and discharge as probed by RIXS;

FIG. 12 shows X-ray diffraction patterns (CuKα, room temperature) of additional compositions with mixed-TM species;

FIG. 13 shows X-ray diffraction patterns (CuKα, room temperature) of additional compositions with various Li contents;

FIG. 14 shows a side-by-side comparison of an ideal spinel (left) and a partially cation-disordered spinel (right); and

FIG. 15. Shows a voltage profile of LiMn₂O₄.

### DETAILED DESCRIPTION OF THE INVENTION

Materials of the present invention include spinel oxides and oxyfluorides that have large and multiple degrees of tunability in Li-excess, TM deficiency, and fluorination levels (when present) at the same time. Spinels of the present invention are different from existing spinel compounds in several aspects. (i) Their compositions have larger deviation from a normal spinel, with a formula of Li₁₊ₓTM_{2-y}O_{4-z}F_{z} (0.2≤x≤1, 0.2≤y≤0.6, 0≤z≤0.8, TM=Mn, Ni, Co, Al, Sc, Ti, Zr, Mg, Nb (can be a single TM element or a combination of multiple TMs). In preferred embodiments, the general formula may be characterized by one or more (including any available combination or sub-combination) of the foregoing stated variables having a narrower range chosen—e.g., (0.4≤x≤1.0, 0.3≤y≤0.6, and 0.2≤z≤0.8). The maximum level of fluorination made possible by the present invention, 0.8 per formula unit, is much higher than what has been reported in the literature, about 0.2 per formula unit. (ii) These formulas are all over-stoichiometric in their cation sublattice, meaning that the cation to anion ratio (atomic) is larger than 3:4 yet smaller than 1:1 (3:4<r<1:1). (iii) The TM species are partial disordered between the two sets of octahedral sites, i.e., the 16c and 16d Wyckoff positions, whereas traditional spinels have TM species confined to one set of octahedral sites. This TM disorder also has an influence on the voltage profiles during electrochemical cycling. (iv) Spinels of the present invention are considered to be the only spinels that utilize oxygen redox during their charge/discharge, with the activation of oxygen redox considered to result from the unconventionally high levels of Li excess and TM deficiency in these compositions. Although oxyfluorides are favored in many applications of the present invention (inclusive of values for z of greater than 0.2 up to 0.8), as seen by the inclusion of “0” in the range of 0 K z K 0.8 above, the present invention is also inclusive of spinel oxides that satisfy the above formula.

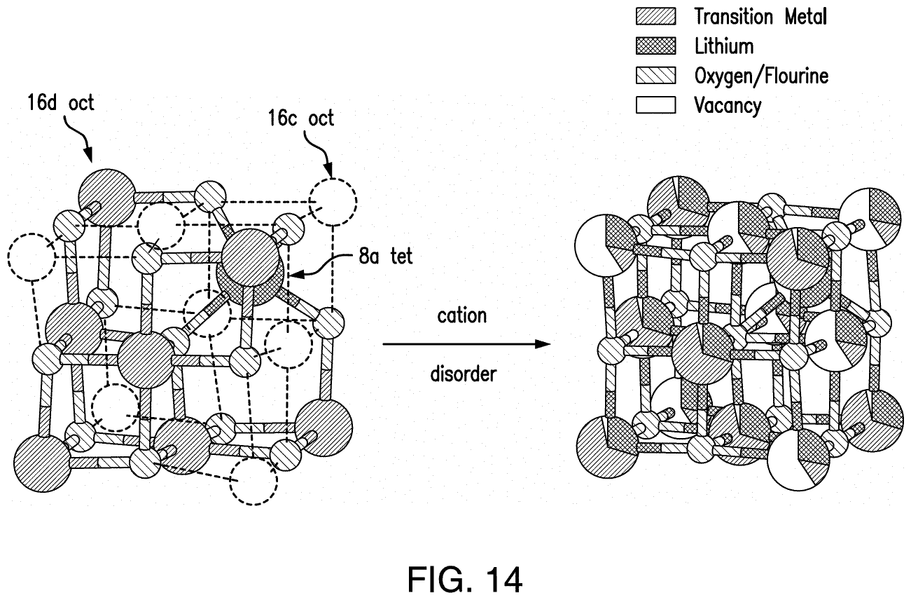

FIG. 14 presents a visual comparison between an ideal spinel (left) and a partially cation-disordered spinel (right). In an ideal spinel, the 16d octahedral sites are fully occupied by TM while the 16c octahedral sites are empty; Li fully occupies the 8a tetrahedral sites. In a partially cation-disordered spinel, TM is partially disordered between the 16c and 16d sites, while Li is distributed among each of the 8a, 16c and 16d sites.

In one example, Li_{1.68}Mn_{1.6}O_{3.7}F_{0.3} (“LMOF03”) and Li_{1.68}Mn_{1.6}O_{3.4}F_{0.6} (“LMOF06”) were synthesized by mixing stoichiometric Li₂MnO₃, MnF₂, Mn₂O₃ and MnO₂ using a Retsch PM200 planetary ball mill. Precursor powder of a batch size of 1 g, along with five 10-mm (diameter) and ten 5-mm (diameter) stainless-steel balls, was dispensed into a 50-ml stainless-steel jar, which was then sealed with safety closure clamps in an argon-filled glovebox. After high-energy ball-milling for 25 and 21 hours, for LMOF03 and LMOF06, respectively, the phase-pure product was obtained mechanochemically. In other examples, different precursors, such as Li₂O, LiF, Mn₂O₃, and MnO₂ may be used, and the target compounds may also be obtained with slightly varied milling times.

The LMOF03 and LMFO06 were used to fabricate cathode electrodes in an argon-filled glovebox. The active material (70 wt %) was first manually mixed with Super C65 carbon black (Timcal, 20 wt %) in a mortar for 45 minutes. After adding polytetrafluoroethylene (PTFE, Dupont, 10 wt %) as a binder, the mixture was rolled into a thin film to be used as a cathode. The loading density of the cathode film is ˜5 mg/cm². Coin cells (CR2032) were assembled by using 1 M LiPF₆ in ethylene carbonate and dimethyl carbonate solution (volumetric 1:1 for EC/DMC) as the electrolyte, glass microfiber filters (Whatman) as separators, and Li metal foil (FMC) as the anode. The sealed coin cells were then tested on an Arbin battery cycler at room temperature. For rate capability tests at high current densities, from 100 to 20000 mA g⁻¹, the weight ratio of active material, carbon black, and binder in cathode films was 40:50:10, and the loading density of the cathode film is 2-3 mg/cm².

Elemental analysis was performed using direct-current plasma emission spectroscopy (ASTM E 1097-12) for metal species and the ion selective electrode method (ASTM D1179-16) for fluorine Neutron powder diffraction and total scattering experiments were carried out at the Spallation Neutron Source at Oak Ridge National Laboratory on the Nanoscale Ordered Materials Diffractometer (NOMAD). The samples for neutron experiments were synthesized using a ⁷Li-enriched precursor of ⁷Li₂MnO₃, which was obtained by calcinating stoichiometric ⁷Li₂CO₃ and MnO₂ in air. All the neutron data was analyzed using TOPAS software package. Scanning TEM, electron diffraction patterns and EDS mapping were acquired in the Molecular Foundry at Lawrence Berkeley National Laboratory on a JEM-2010F microscope equipped with an X-mas EDS detector. SEM images were also obtained in the Molecular Foundry on a Zeiss Gemini Ultra 55 analytical field-emission scanning electron microscope.

Hard X-ray absorption spectroscopy (XAS) measurements at the Mn K-edge were conducted in transmission mode at room temperature at the Advanced Photon Source (APS) at Argonne National Laboratory. Resonant inelastic X-ray scattering (RIXS) at the O K-edge was conducted at the Advanced Light Source (ALS) in Lawrence Berkeley National Laboratory.

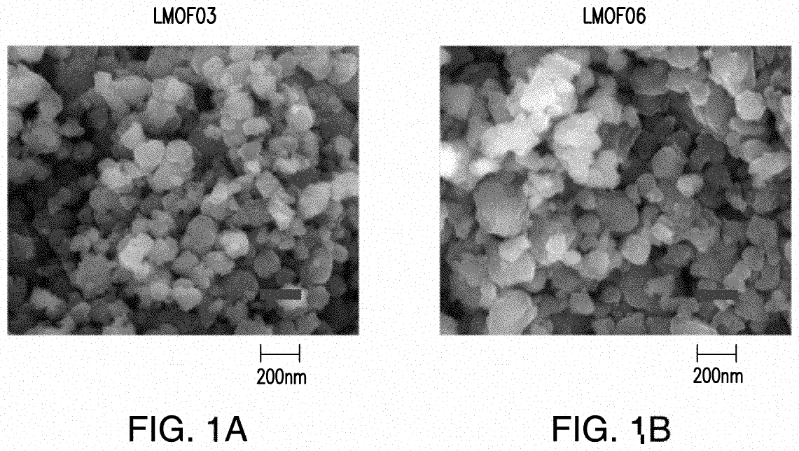

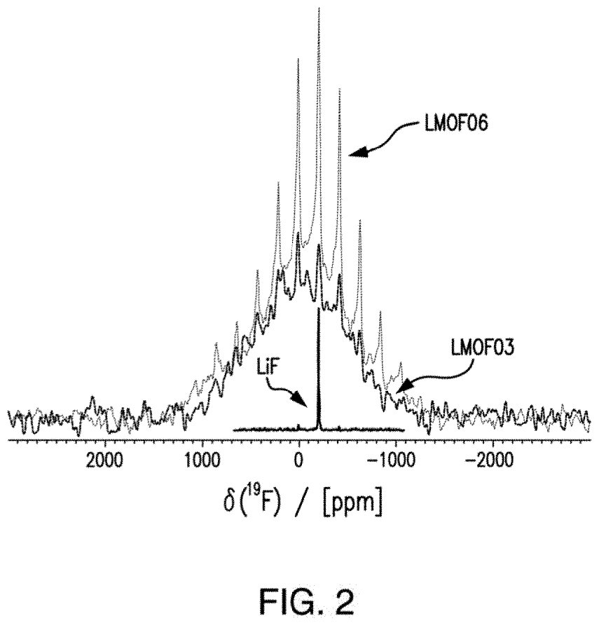

The scanning electron microscopy images of the as-ball-milled particles of LMOF03 and LMOF06 are presented in FIGS. 1A and 1, respectively. Based on these images, the primary particle size is estimated to be 100-200 nm for LMOF03 and 100-300 nm for LMOF06. The ¹⁹F solid-state spin echo ssNMR spectra of LMOF03, LMOF06, and LiF powder are shown in FIG. 2. The spectra obtained are ¹⁹F spin echo ssNMR spectra, at 60 kHz MAS, on pristine sample powder; and the figure illustrates the spectra scaled according to the number of scans in the experiment and the amount of sample in the NMR rotor. The NMR spectra contain information about the chemical environment around F ions. Both the as-synthesized LMOF03 and LMOF06 show broad signals that span a wide range of chemical shift, which is significantly different from the sharp signal centered at −204 ppm for LiF. This is indicative of bulk fluorine incorporation in the spinels of both LMOF03 and LMOF06. Although some diamagnetic signals are observed (more pronounced in LMOF06 than in LMOF03), which suggests the existence of minor impurities (e.g., Li₂, LiF and Li₂CO₃), the contribution from LiF-like domains in the target bulk compounds cannot be ruled out. Elemental analysis results in the following Table 1 further indicate that the compositions of the as-synthesized compounds are close to the target.

TABLE 1
Target vs. measured Li:Mn:F atomic ratio of LMOF03
and LMOF06 compounds by direct current plasma emission
spectroscopy and ion selective electrodes

| Material | Target Li:Mn:F | Measured Li:Mn:F |
|---|---|---|
| LMOF03 | 1.68:1.6:0.3 | 1.70:1.59:0.29 |
| LMOF06 | 1.68:1.6:0.6 | 1.70:1.55:0.62 |

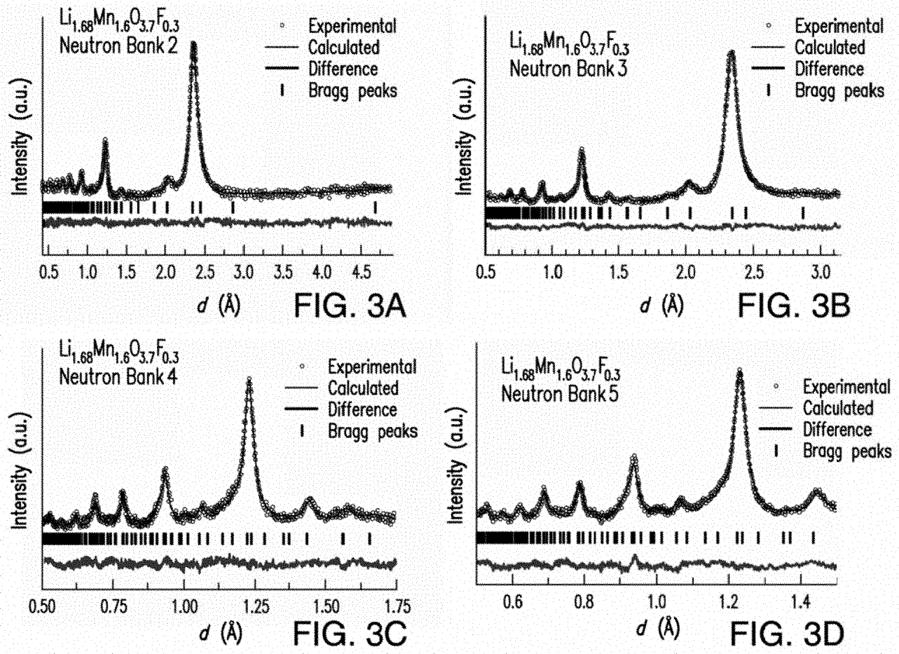

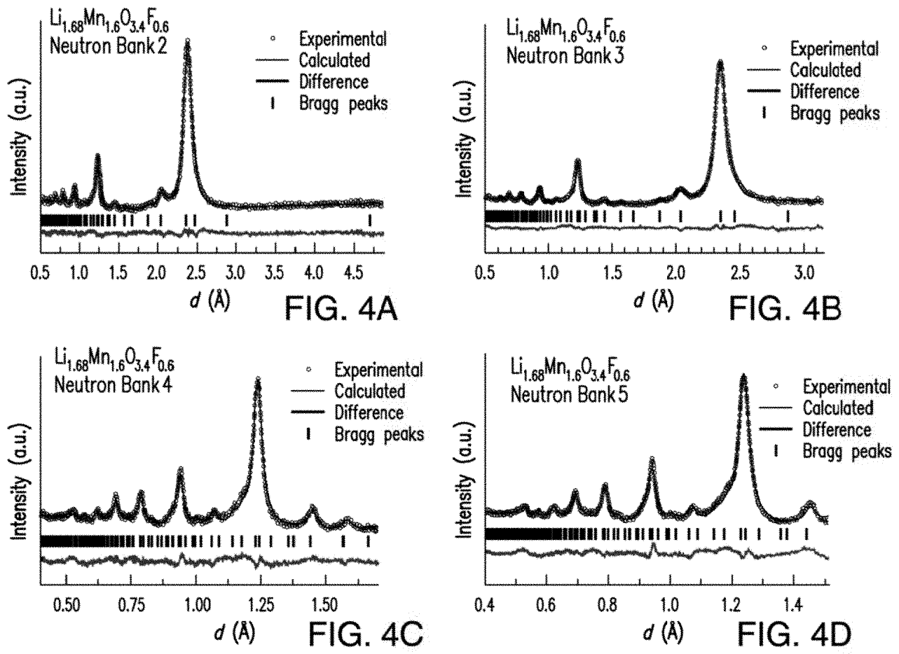

The crystal structures of LMOF03 and LMOF06 were refined through Rietveld refinement using four banks of time-of-flight (TOF) neutron diffraction data, at room temperature. Good agreement between neutron diffraction and the resolved structure models is shown in FIGS. 3A-3D and 4A-4D, and in Tables 2, 3 and 4 below. The lattice parameter was refined to be 8.1161 Å for LMOF03 and 8.1458 Å for LMOF06. Both compounds adopt a spinel structure (space group: Fd-3m) with considerable amount of cation disorder, which is different from an ideal spinel such as LiMn₂O₄, in which Li fully occupies the 8a site and Mn fully occupies the 16d site. Instead, only half of the 8a site is occupied by Li in LMOF03 and LMOF06 (though it is to be understood that Li may occupy anywhere from 20-70%), and the rest of the Li content is extensively distributed in the 16c and 16d sites. It was also observed that LMOF03 contains more Li in the 16d site than LMOF06, though the Mn distribution (obtained through synchrotron powder diffraction refinement) is comparable between the two. While not being bound by theory, it is considered this difference might originate from the different F contents.

TABLE 2
Details about neutron powder diffraction refinement

| | | |
|---|---|---|
| Compounds | LMOF03 | LMOF06 |

| | |
|---|---|
| Space group | Fd-3m |
| Temperature | 300 K |
| Formula units/cell | 8 |

| | | |
|---|---|---|
| Lattice parameter a (Å) | 8.1161(16) | 8.1458(14) |
| Cell volume (Å³) | 534.6(3) | 540.5(3) |
| R_{wp} | 3.66% | 4.04% |
| GoF | 1.14 | 1.54 |

TABLE 3
Extra structural parameters for LMOF03 from neutron powder diffraction refinement

| Atom | Wyckoff symbol | x | y | z | Uiso | occupancy |
|---|---|---|---|---|---|---|
| Li1 | 8a | 0.125 | 0.125 | 0.125 | 1.54198 | 0.52 (5) |
| Li2 | 16d | 0.5 | 0.5 | 0.5 | 1.54198 | 0.297 (17) |
| Li3 | 16c | 0 | 0 | 0 | 1.54198 | 0.281 (18) |
| Mn1 | 16d | 0.5 | 0.5 | 0.5 | 0.49845 | 0.67 |
| Mn2 | 16c | 0 | 0 | 0 | 0.49845 | 0.13 |
| O1 | 32e | 0.25969 (11) | 0.25969 (11) | 0.25969 (11) | 0.63 (3) | 0.925 |
| F1 | 32e | 0.25969 (11) | 0.25969 (11) | 0.25969 (11) | 0.63 (3) | 0.075 |

TABLE 4
Extra structural parameters for LMOF06 from neutron powder diffraction refinement

| Atom | Wyckoff symbol | x | y | z | Uiso | Occupancy |
|---|---|---|---|---|---|---|
| Li1 | 8a | 0.125 | 0.125 | 0.125 | 1.54198 | 0.54 (4) |
| Li2 | 16d | 0.5 | 0.5 | 0.5 | 1.54198 | 0.145 (14) |
| Li3 | 16c | 0 | 0 | 0 | 1.54198 | 0.424 (14) |
| Mn1 | 16d | 0.5 | 0.5 | 0.5 | 0.47983 | 0.69 |
| Mn2 | 16c | 0 | 0 | 0 | 0.47983 | 0.11 |
| O1 | 32e | 0.25955 (11) | 0.25955 (11) | 0.25955 (11) | 1.18 (3) | 0.85 |
| F1 | 32e | 0.25955 (11) | 0.25955 (11) | 0.25955 (11) | 1.18 (3) | 0.15 |

TABLE 5
Details about neutron powder diffraction refinement

| Compounds | Li_{1.46}Mn_{1.6}O_{3.7}F_{0.3} | Li₂Mn_{1.6}O_{3.7}F_{0.3} |
|---|---|---|
| Space group | Fd-3m | |
| Temperature | 300 K | |
| Formula units/cell | 8 | |
| Lattice parameter a (Å) | 8.1161(17) | 8.1539(10) |
| Cell volume (Å³) | 534.6(3) | 542.1(2) |
| R_{wp} | 4.42% | 4.01% |
| GoF | 1.42 | 1.16 |

TABLE 6
Extra structural parameters for Li_{1.46}Mn_{1.6}O_{3.7}F_{0.3}
from neutron powder diffraction refinement

| Atom | Wyckoff symbol | x | y | z | Uiso | occupancy |
|---|---|---|---|---|---|---|
| Li1 | 8a | 0.125 | 0.125 | 0.125 | 1.50053 | 0.67 (4) |
| Li2 | 16d | 0.5 | 0.5 | 0.5 | 1.50053 | 0.178 (15) |
| Li3 | 16c | 0 | 0 | 0 | 1.50053 | 0.224 (15) |
| Mn1 | 16d | 0.5 | 0.5 | 0.5 | 0.48 (5) | 0.67 |
| Mn2 | 16c | 0 | 0 | 0 | 0.48 (5) | 0.13 |
| O1 | 32e | 0.26138 (10) | 0.26138 (10) | 0.26138 (10) | 0.70 (3) | 0.925 |
| F1 | 32e | 0.26138 (10) | 0.26138 (10) | 0.26138 (10) | 0.70 (3) | 0.075 |

TABLE 7
Extra structural parameters for Li₂Mn_{1.6}O_{3.7}F_{0.3}
from neutron powder diffraction refinement

| Atom | Wyckoff symbol | x | y | z | Uiso | occupancy |
|---|---|---|---|---|---|---|
| Li1 | 8a | 0.125 | 0.125 | 0.125 | 1.54198 | 0.22 (5) |
| Li2 | 16d | 0.5 | 0.5 | 0.5 | 1.54198 | 0.295 (19) |
| Li3 | 16c | 0 | 0 | 0 | 1.54198 | 0.596 (19) |
| Mn1 | 16d | 0.5 | 0.5 | 0.5 | 0.40 (4) | 0.67 |
| Mn2 | 16c | 0 | 0 | 0 | 00.40 (4) | 0.13 |
| O1 | 32e | 0.25700 (13) | 0.25700 (13) | 0.25700 (13) | 1.22 (3) | 0.925 |
| F1 | 32e | 0.25700 (13) | 0.25700 (13) | 0.25700 (13) | 1.22 (3) | 0.075 |

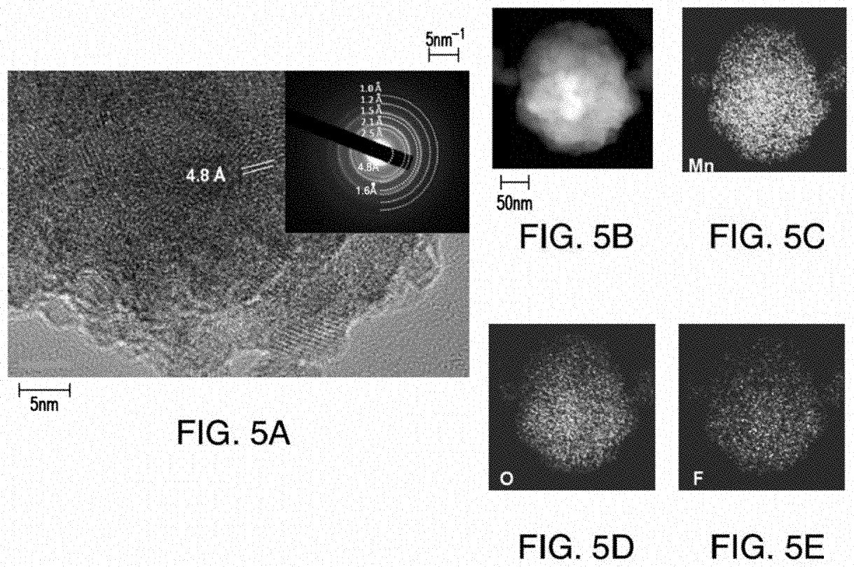

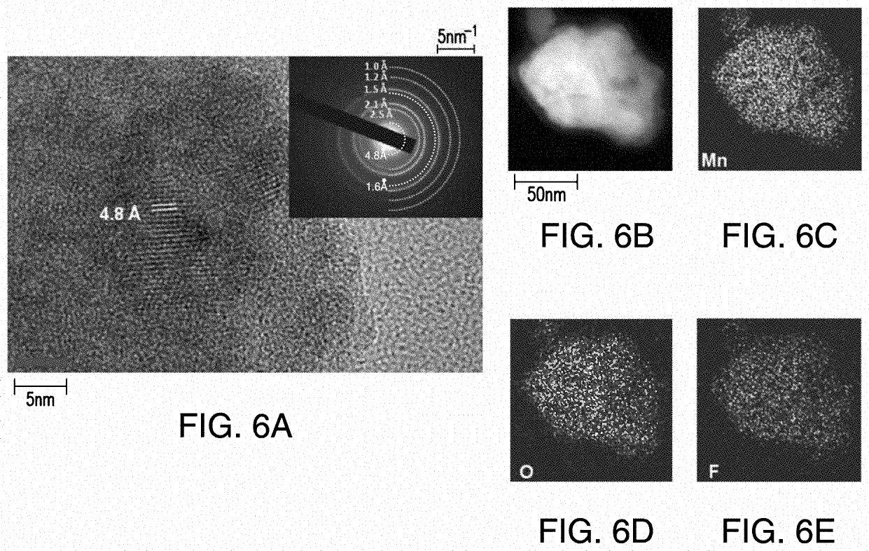

To further verify the distribution of elemental components in the as-synthesized materials, TEM-EDS was performed on the LMOF03 and LMOF06 particles. FIGS. 5A-5E show a high-resolution transmission electron microscopy (TEM) image of LMOF03, and corresponding electron diffraction imaging with EDS mapping of Mn, O, and F; and FIGS. 6A-6E show a high-resolution TEM image of LMOF06, and corresponding electron diffraction imaging with EDS mapping of Mn, O, and F. From the EDS mapping, there was detected uniform distribution of Mn, O and F in both materials. The crystallite size is estimated to be 10-15 Å. The electron diffraction patterns of the imaged particles are shown on the upper right corner of the HRTEM images (FIGS. 5A and 6A) and are indexed based on a spinel structure. As shown in the upper right corners of FIGS. 5A and 6A, characteristic d-spacing of ˜4.8 Å for the (111) planes is observed in both the LMOF03 and LMOF06 compounds on properly oriented crystallite grains.

Combining the above neutron diffraction refinement, NMR, TEM-EDS, and elemental analysis, it was concluded that the two target compounds are successfully made using mechanochemical alloying (i.e., high-energy ball-milling) with a partially disordered spinel lattice.

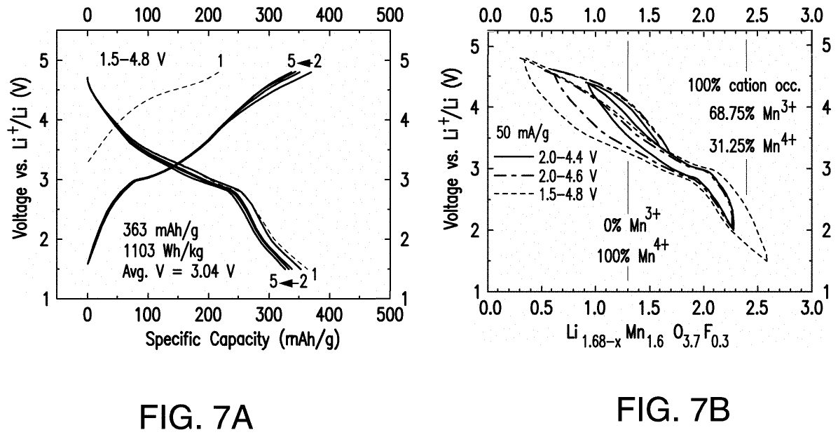

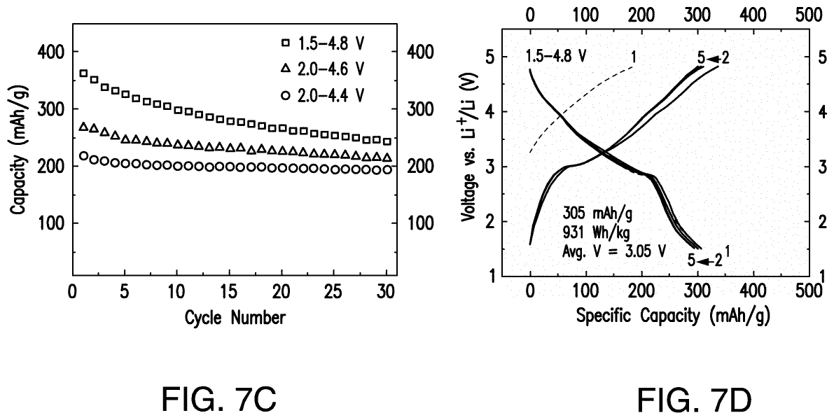

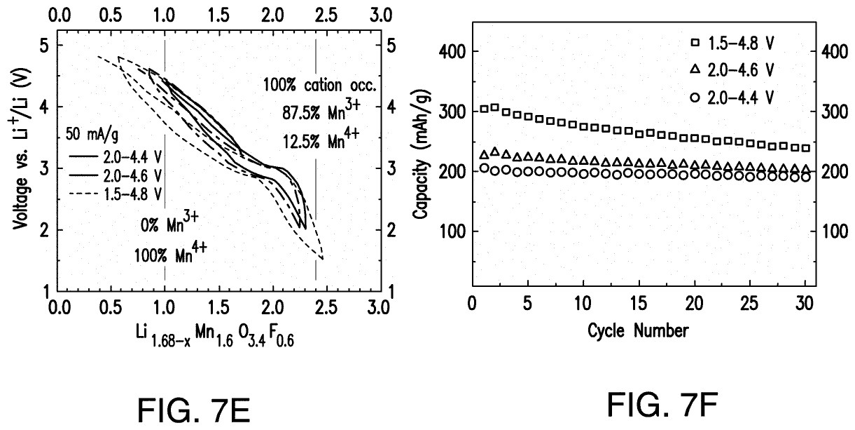

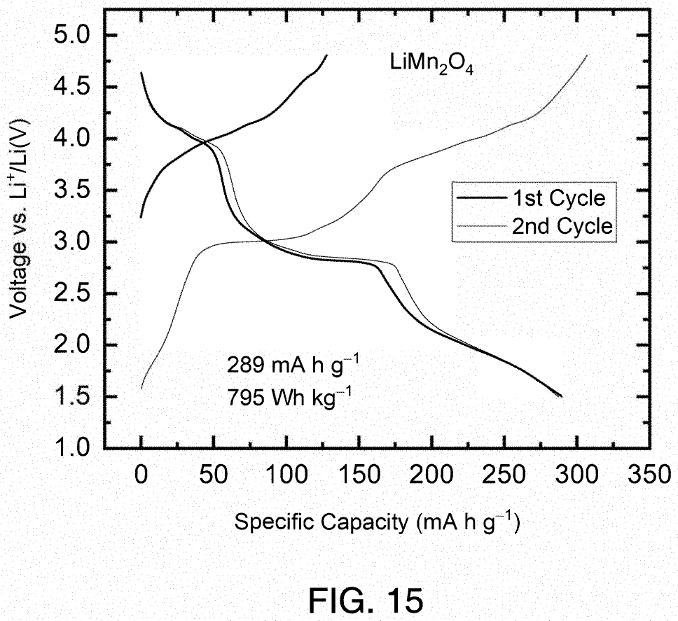

To test the electrochemical properties of the as-synthesized LMOF03 and LMOF06, galvanostatic cycling tests were performed in various voltage windows at a rate of 50 mA g-1. FIGS. 7A-7C show the test results of LMOF03, and FIGS. 7D-7F show the test results of LMOF06. FIGS. 7A and 7D show the initial five-cycle voltage profiles of LMOF03 and LMOF06, respectively between 1.5-4.8 V at room temperature; FIGS. 7B and 7E show voltage profiles for the first cycle in various voltage windows; and FIGS. 7C and 7F show capacity retention in various voltage windows. Their voltage profiles are considerably different from a normal spinel, e.g., LiMn₂O₄ or LiNi0.5Mn_{1.5}O₄, which typically shows two equally long plateaus at >4 V and ˜2.7 V, corresponding to the extraction/reinsertion of Li in two distinct sites, i.e., tetrahedral and octahedral. FIG. 15 presents a voltage profile of LiMn₂O₄ for comparison with the LMOF03 and LMOF06 profiles of FIGS. 7A and 7D. As seen in FIG. 15, the profile for LiMn₂O₄ presents extended plateaus, and limited gravimetric energy density.

For materials of the present invention, the plateau above 4 V is barely visible in LMOF03 and LMFO06, instead being replaced with a smooth and sloped profile, which is favorable for the monitoring of state of charge in a battery. Only a small plateau region of less than 30 mA h g⁻¹ is observed at ˜2.7 V. While not being bound by theory, it is considered the absence of plateau at 4 V is likely due to low population of Li in tetrahedral sites and that the favorable smooth voltage profiles observed during electrochemical cycling of both LMOF03 and LMOF06 are influenced by the TM disorder between the two sets of octahedral sites, e.g., 16c and 16d Wyckoff positions, of these as-synthesized materials, whereas conventional spinels have TM species confined to one set of octahedral sites. This TM disorder also has an influence on the voltage profiles during electrochemical cycling, such that the total capacity extracted from the voltage plateau region(s) (aka flat-voltage region(s)) in the discharge voltage profile between 1.5-4.8 V during the first cycle is less than 50 mA h g⁻¹. The sloping voltage profile can be explained by a wide distribution of Li site energy caused by TM disorder¹¹. A voltage plateau during discharge is quantitatively defined here as a continuous voltage profile region having an average slope larger than −0.002 V g mA⁻¹ h⁻¹ but smaller than 0. It is also observed that, within this voltage window, LMOF03 and LMOF06 can deliver a high discharge capacity up to ˜363 mA h g⁻¹ (1103 W h kg⁻¹) and ˜305 mA h g⁻¹ (931 W h kg⁻¹), respectively. The average discharge voltages for LMOF03 and LMOF06 are 3.04 V and 3.05 V, respectively. The capacity (and specific energy) of LMOF03 reduces to 268 mA h g⁻¹ (868 W h kg⁻¹) or 218 mA h g⁻¹ (690 W h kg⁻¹), when cycled in narrower voltage windows of 2.0-4.6 V or 2.0-4.4 V, respectively; whereas the capacity (and specific energy) of LMOF06 reduces to 226 mA h g⁻¹ (731 W h kg⁻¹) or 207 mA h g⁻¹ (657 W h kg⁻¹), when cycled in narrower voltage windows of 2.0-4.6 V or 2.0-4.4 V, respectively. The voltage hysteresis in various windows is shown in FIGS. 7B and 7E for LMOF03 and LMOF06, respectively. LMOF06 has much reduced voltage hysteresis compared to LMOF03, likely because of its larger theoretical capacity based on Mn redox (as illustrated with uniformly-spaced dashed lines). The voltage hysteresis is most pronounced for LMOF03 when x<1.0, a region where oxygen redox is expected to dominate. Both compounds show promising capacity retention as crude materials without requiring extra coating or electrolyte additives—though, it will be understood that the present invention nonetheless encompasses such materials with the further presence of one or more extra coatings or electrolyte additives. The cyclability is exceptionally good in narrower voltage windows, e.g., 2-4.4 V or 2-4.6 V, with >200 mA h g⁻¹ capacity.

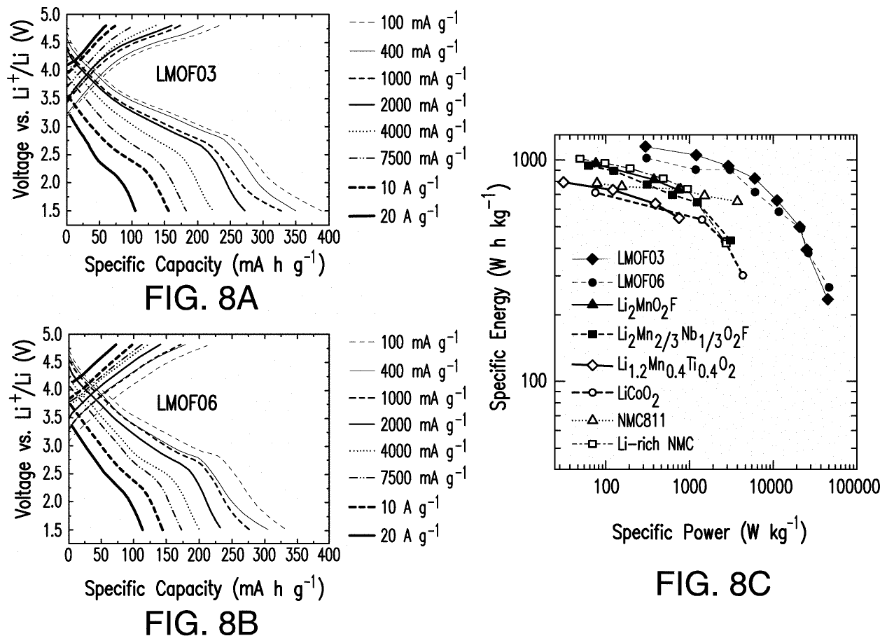

Rate-capability tests were performed on the two as-synthesized materials using cathode films fabricated with a formula of 40:50:10 in weight ratio for active material, carbon black and PTFE. The loading density of the cathode film was 2-3 mg cm⁻². FIGS. 8A and 8B show the galvanostatic charge/discharge profiles of LMOF03 (FIG. 8A) and LMOF06 (FIG. 8B) at various rates (i.e., 100, 200, 400, 1000, 2000, 4000, 10000, and 20000 mA g⁻¹) between 1.5 and 4.8 V. A fresh cell was used for each rate test, with the cell being charged to 4.8 V at the selected rate, followed by 1-min resting, and then discharged at the given rate to 1.5 V. With a 40:50:10 cathode formula, the highest specific energy obtained was 1155 Wh/kg from LMOF03 and 1020 Wh/kg from LMOF06. When cycled at a high rate of 2 A/g, the achieved gravimetric energy density is still as high as 823 Wh/kg for LMOF03 and 714 Wh/kg for LMOF06. Both materials demonstrated excellent rate capability. As the rate increases from 100 to 20000 mA/g, the discharge capacity of LMOF03 decreases from 388 to 105 mA h g⁻¹ (FIG. 8A), while that of LMOF06 decreases from 333 to 113 mA h g⁻¹ (FIG. 8B). The rate capability of LMOF03 and LMOF06 is considerably better than the most optimized rate performance of the state-of-the-art cathode materials, as shown in a Ragone plot in FIG. 8C with a comparison of the specific energy and power density for both LMOF03 and LMOF06 relative to other state-of-the-art materials with optimized rate performance, as reported in literatures⁵⁻¹⁰.

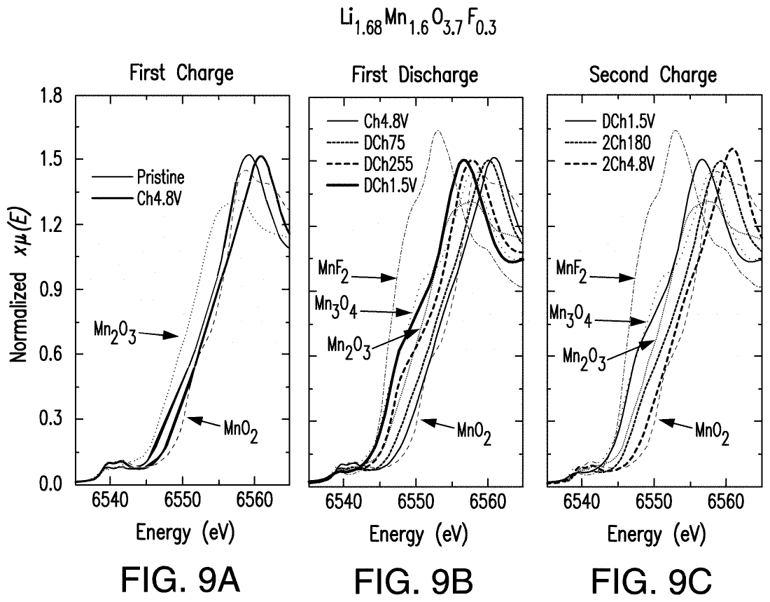

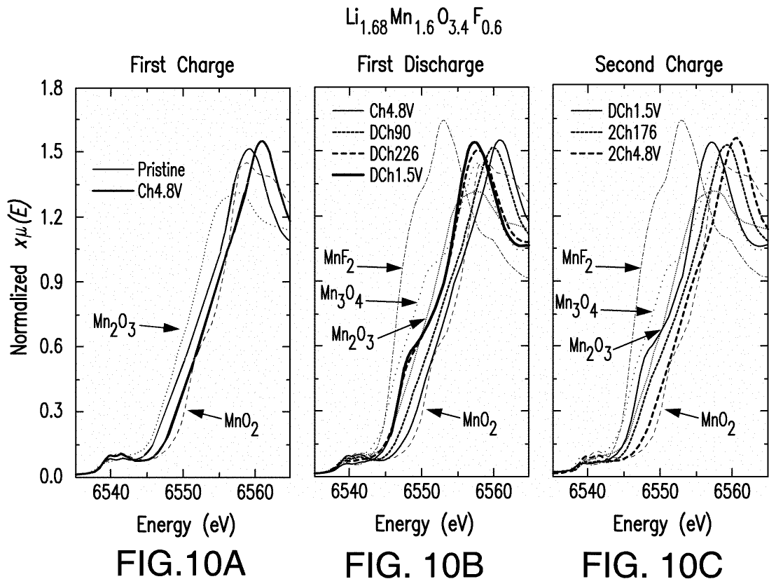

FIGS. 9A-9C and 10A-10C present the normalized Mn K-edge XANES spectra of LMOF03 (FIGS. 9A-9C) and LMOF06 (FIGS. 10A-10C) during the first cycle and the second charge. Several representative states are selected including a first charge phase between pristine and Ch4.8V in FIGS. 9A and 10A; a first discharge phase between Ch4.8V and DCh1.5V in FIGS. 9B and 10B; as well as a second charge phase, during a second cycle, between DCh1.5V and 2Ch4.8V in FIGS. 9C and 10C. MnF₂, Mn₃O₄, Mn₂O₃, and MnO₂ are used as Mn²⁺, Mn^{8/3+}, Mn³⁺, and Mn⁴⁺ standards, respectively. LMOF06 pristine powder has a slightly reduced Mn oxidation state compared to that of LMOF03, and both are oxidized to close to Mn⁴⁺ upon being charged to 4.8 V. Upon discharge, the Mn K-edge shifts to a lower oxidation state than the pristine state because the discharged cathode contains more Li, and therefore more reduced Mn, than pristine.

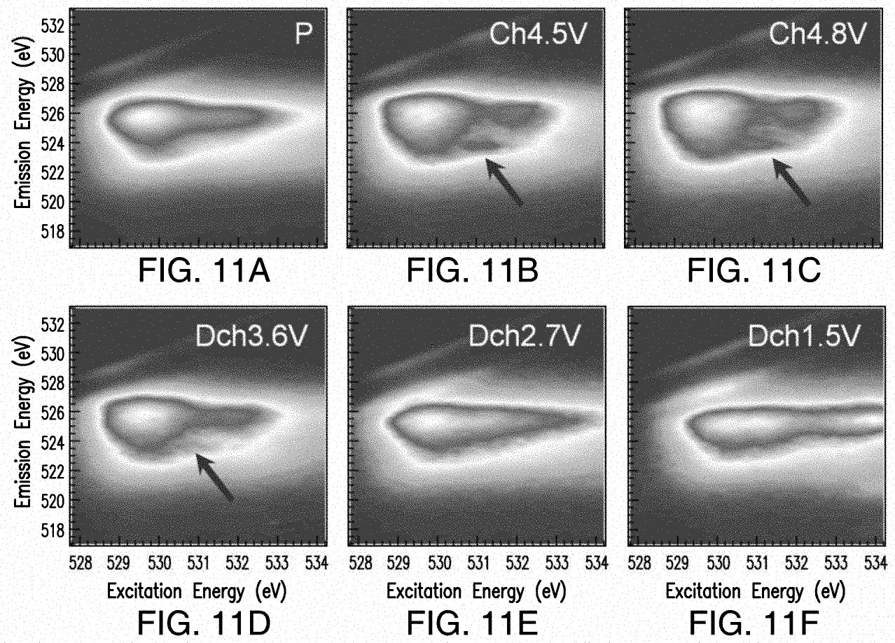

For LMOF03, in which oxygen redox is expected given the considerably larger-than-theoretical capacity, additional resonant inelastic X-ray scattering (RIXS) data at the O K-edge was collected. The results are shown in FIGS. 11A-11F, which show electronic structures of oxygen in LMOF03 at various states of charge and discharge as probed by RIXS. Upon being charged to 4.5 V, a sharp feature at 531 eV excitation energy and 524 eV emission energy (seen at the arrow in each of FIGS. 11B, 11C and 11D) appears, which grows further in intensity when charged to 4.8 V. This feature is the characteristic signal associated with oxidized oxygen⁴, indicating that LMOF03 undergoes lattice oxygen oxidation during charge, making it the first spinel with oxygen redox. It is also a rare case in which a cathode exhibits excellent rate performance when oxygen redox is involved. The O K-edge feature lingers when discharged to 3.6 V (FIG. 11D) from the remaining unreduced lattice oxygen and eventually disappears at 2.7 V (FIG. 11E).

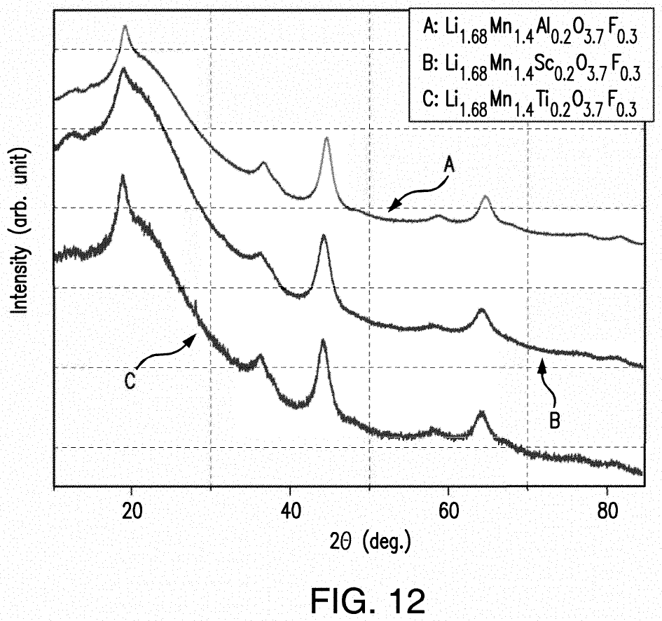

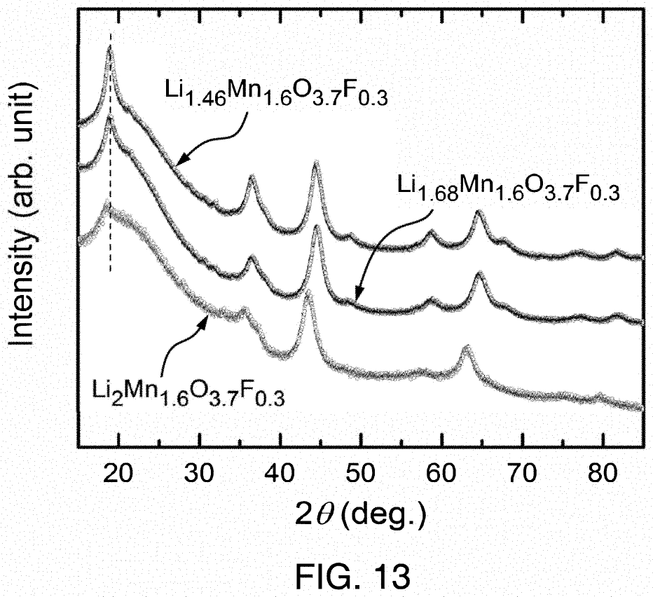

FIG. 12 demonstrates the chemical flexibility in this class of materials, showing additional X-ray diffraction patterns of Li_{1.68}Mn_{1.4}Sc_{0.2}O_{3.7}F_{0.3}, Li_{1.68}Mn_{1.4}Al_{0.2}O_{3.7}F_{0.3}, and Li_{1.68}Mn_{1.4}Ti_{0.2}O_{3.7}F_{0.3}, which can all be synthesized with a spinel structure according to the present invention. FIG. 13 shows more examples demonstrating the synthesizability of these materials with various Li contents. The partial TM disorder is manifested in X-ray diffraction as shown in FIG. 13 by comparing three samples with various Li over-stoichiometry levels, namely Li_{1.46}Mn_{1.6}O_{3.7}F_{0.3}, Li_{1.68}Mn_{1.6}O_{3.7}F_{0.3} and Li₂Mn_{1.6}O_{3.7}F_{0.3}. Unlike an ideal spinel LiTM₂O₄, wherein the (111) peak (at ˜19 degrees for X-ray generated by a Cu source) should be the one with the highest intensity (almost twice as strong as the (400) peak at ˜43 degrees for X-ray generated by a Cu source), these three samples with partial TM disorder all show a reduced intensity in the (111) peak. In addition, the intensity of the (111) peak noticeably decreases from Li_{1.46}Mn_{1.6}O_{3.7}F_{0.3} to Li_{1.68}Mn_{1.6}O_{3.7}F_{0.3} to Li₂Mn_{1.6}O_{3.7}F_{0.3}, suggesting more significant TM disorder, consistent with the trend obtained from neutron refinement, see for example Tables 2-7. It is also noted that in FIG. 13, the broad background between 15 degrees to roughly 50 degrees comes from holders and grease used for sample preparation and short-range order in samples, and only signals extruding from the background are counted as X-ray diffraction peaks.

It is noted that prior studies in this art have addressed spinel cathodes, with a focus on either low-level fluorination (<0.2 out of 4 anions per formula unit) or optimizing the rate capability of stoichiometric spinels through nano-sizing. In contrast, the present invention allows for large and multiple degrees of freedom in Li-excess, TM deficiency, and fluorination levels, which can be individually tuned through a high-energy ball-milling method. As mentioned before, the compositions are different from the existing ones in, for example, the following aspects: (i) they have larger deviation from the stoichiometry of a normal spinel and a fluorination level that is higher than previously achieved; (ii) they all have cation over-stoichiometry, meaning the total count of cations per formula unit is over three; (iii) they all have partial TM disorder between the two octahedral sites, i.e., 16c and 16d, which leads to smooth voltage profiles rather than the typical two-plateau profiles in a normal spinel; and (iv) they are the considered to be the only spinels that use oxygen redox during electrochemical cycling. As a result of these differentiating features, several important cathode metrics, including specific energy, capacity, cyclability, and rate capability, can be systematically and individually optimized.

The invention described and claimed herein is not limited in scope by the specific embodiments herein disclosed, since these embodiments are intended as illustrations of several aspects of the invention. Any equivalent embodiments of the invention to those shown and described will become apparent to those skilled in the art from the forgoing description. Such modifications are intended to fall within the scope of the appended claims. All patent and patent applications cited in the foregoing text are expressly incorporated herein by reference in their entirety.

### CITED REFERENCES

1 Kang, B. & Ceder, G. Battery materials for ultrafast charging and discharging. Nature 458, 190 (2009).
2 Kang, K., Meng, Y. S., Bréger, J., Grey, C. P. & Ceder, G. Electrodes with high power and high capacity for rechargeable lithium batteries. Science 311, 977-980 (2006).
3 Urban, A., Lee, J. & Ceder, G. The Configurational Space of Rocksalt-Type Oxides for High-Capacity Lithium Battery Electrodes. Advanced Energy Materials 4, 1400478 (2014).
4 Yang, W. & Devereaux, T. P. Anionic and cationic redox and interfaces in batteries: Advances from soft X-ray absorption spectroscopy to resonant inelastic scattering. Journal of Power Sources 389, 188-197 (2018).
5 Ji, H. et al. Hidden structural and chemical order controls lithium transport in cation . . . disordered oxides for rechargeable batteries. Nature communications 10, 592 (2019).
6 Lee, J. et al. Reversible Mn 2+/Mn 4+ double redox in lithium-excess cathode materials. Nature 556, 185 (2018).
7 House, R. A. et al. Lithium manganese oxyfluoride as a new cathode material exhibiting oxygen redox. Energy & Environmental Science 11, 926-932 (2018).
8 Jo, M., Hong, Y.-S., Choo, J. & Cho, J. Effect of LiCoO2 cathode nanoparticle size on high rate performance for Li-ion batteries. Journal of The electrochemical society 156, A430 . . . A434 (2009).
9 Martha, S. K., Nanda, J., Veith, G. M. & Dudney, N. J. Electrochemical and rate performance study of high-voltage lithium-rich composition: Li1.2Mn0.525Ni0.175Co0.1O2. Journal of Power Sources 199, 220-226 (2012).
10 Noh, H.-J., Youn, S., Yoon, C. S. & Sun, Y.-K. Comparison of the structural and electrochemical properties of layered Li[NixCoyMnz]O2 (x=⅓, 0.5, 0.6, 0.7, 0.8 and 0.85) cathode material for lithium . . . ion batteries. Journal of power sources 233, 121 . . . 130 (2013).
11 Abdellahi, A., Urban, A., Dacek, S., Ceder, G. Understanding the Effect of Cation Disorder on the Voltage Profile of Lithium Transition-Metal Oxides. Chem. Mater. 2016, 28, 5373-5383 (2016).

1. A lithium metal oxide or oxyfluoride compound having a general formula: Li₁₊ₓTM_{2-y}O_{4-z}F_{z}, wherein 0.2≤x≤1, 0.2≤y≤0.6, and 0≤z≤0.8, and TM is Mn, Ni, Co, Al, Sc, Ti, Zr, Mg, Nb, or a mixture thereof.

2. The compound of claim 1, wherein the compound is defined by (0.4≤x≤1.0).

3. The compound of claim 1, wherein the compound is defined by (0.3≤y≤0.6).

4. The compound of claim 1, wherein the compound is defined by (0.2≤z≤0.8).

5. The compound of claim 1, wherein the compound is Li_{1.68}Mn_{1.6}O_{4-z}F_{z}.

6. The compound of claim 1, wherein the compound is Li_{1.68}Mn_{1.6}O_{3.7}F_{0.3}.

7. The compound of claim 1, wherein the compound is Li_{1.68}Mn_{1.6}O_{3.4}F_{0.6}.

8. The compound of claim 1, wherein the compound comprises a spinel structure.

9. The compound of claim 8, wherein the spinel structure is adapted for low-energy Li migration through 0-TM channels.

10. The compound of claim 8, wherein the spinel structure comprises an Fd-3m space group, and the cations are mixed such that Li occupies up to 70% of the 8a site, with additional Li distributed in the 16c and 16d sites.

11. The compound of claim 8, wherein the spinel structure comprises transition metal species mixed between the 16c and 16d sites, though with one of the 16c and 16d sites more dominantly occupied than the other.

12. The compound of claim 8, wherein the spinel structure comprises a crystallite size of 10-15 Å.

13. The compound of claim 8, wherein the spinel structure comprises a d-spacing of 4.8 Å±0.2 Å in the (111) planes.

14. The compound of claim 1, wherein the compound has a cation to anion ratio (r) in a range of 3:4<r<1:1.

15. The compound of claim 14, wherein the compound has a cation to anion ratio (r) of 3.28:4.

16. The compound of claim 8, wherein the compound is adapted to utilize oxygen redox during charge and discharge phases.

17. The compound of claim 1, wherein the compound has a maximum gravimetric energy density between 1000 Wh/kg and 1155 Wh/kg.

18. The compound of claim 1, wherein the compound has an over-stoichiometric cation sublattice.

19. An electrode material, comprising:
a compound according to claim 1.

20. A lithium-ion battery, comprising:
an electrolyte; and
the electrode material of claim 19.

21. The lithium-ion battery of claim 20, wherein the electrode material forms a cathode.

22. A portable electronic device, an automobile, or an energy storage system, comprising:
the lithium-ion battery of claim 20.

23. A lithium-ion battery, comprising:
an electrolyte; an anode; and a cathode, wherein
at least one of the electrolyte, the anode, and the cathode is composed, at least in part, of a compound according to claim 1.

24. A portable electronic device, an automobile, or an energy storage system, comprising:
the lithium-ion battery of claim 23.

25. A method of making a compound according to claim 1, comprising
combining a collection of stoichiometric compounds composed of Li, Mn, O, and F to yield a precursor powder; and
mechanically mixing the precursor powder to obtain the phase pure powder through mechanochemical alloying.

26. The method according to claim 25, wherein
the precursor powder is subjected to mechanical mixing by dispensing the precursor powder into a planetary ball mill.

27. The method according to claim 26, wherein
one gram of the precursor powder is mixed in the planetary ball mill with five 10-mm stainless steel balls and ten 5-mm stainless steel balls.

28. The method according to claim 26, wherein
the precursor powder is mixed in the planetary ball mill for 16 to 26 hours.

29. The method according to claim 26, wherein
the precursor powder is mixed in the planetary ball mill for 20 to 30 hours.

30. The method according to claim 25, wherein
the collection of stoichiometric compounds composed of Li, Mn, O, and F comprises stoichiometric Li₂O, LiF, Mn₂O₃, and MnO₂.

31. The method according to claim 25, wherein
the collection of stoichiometric compounds composed of Li, Mn, O, and F comprises stoichiometric Li₂MnO₃, MnF₂, Mn₂O₃, and MnO₂.

32. The compound of claim 1, wherein the compound is Li_{1.68}Mn_{1.4}TM_{0.2}O_{4-z}F_{z}.

33. The compound of claim 32, wherein TM is chosen from Sc, Al, and Ti.

34. The compound of claim 32, wherein z is 0.3.

35. A lithium-excess, transition-metal-deficient spinel structured lithium-ion metal comprising a lithium metal oxide or oxyfluoride compound having a general formula: Li₁₊ₓTM_{2-y}O_{4-z}F_{z}, wherein 0.2≤x≤1, 0.2≤y≤0.6, and 0≤z≤0.8, and TM is Mn, Ni, Co, Al, Sc, Ti, Zr, Mg, Nb, or a mixture thereof.

36. The lithium-ion metal of claim 35, further comprising a partial cation disordered configuration.
